(19) United States
(12) Patent Application Publication
(10) Pub. No.: US 2009/0106086 A1
(43) Pub. Date: Apr. 23, 2009

(54) Systems and Methods for Planning, Estimating and Billing Advertising Impressions

(76) Inventors: John Morgan, Salt Lake City, UT (US); Robert Wolf, Sandy, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/234,476

(22) Filed: Sep. 19, 2008

Related U.S. Application Data
(60) Provisional application No. 60/974,330, filed on Sep. 21, 2007.

(51) Int. Cl. G06Q 30/00

(52) U.S. Cl. 705/10; 705/400; 705/14

(57) ABSTRACT

The present invention relates to systems and methods for determining the number advertising impressions delivered by advertisements. The present invention also relates to systems and methods for planning and billing advertising. Herein are disclosed a variety of measures, estimates, and indexes that may be used to improve the accuracy of advertisement estimation. Also disclosed are methods and systems for using the described indexes and modifiers to plan, estimate, and bill advertisements.

### RELATED APPLICATIONS

This application claims priority to U.S. Provisional Patent Application Ser. No. 60/974,330, filed Sep. 21, 2007, entitled “Systems and Methods for Planning, Estimating, and Billing Advertising Impressions.”

### BACKGROUND OF THE INVENTION

1. Field of the Invention

The present invention relates to systems and methods for estimating advertising effectiveness. In particular, the present invention relates to systems and methods for planning, estimating, and billing advertising impressions delivered to consumers.

2. Background

Advertising plays an important role in the marketing plan of companies. Advertising is a way by which companies promote their goods or services to consumers. Because advertising is effective for convincing consumers to purchase goods and services, advertising is present in almost every aspect of a consumer's life and is presented to consumers through a variety of means. Advertising is presented as printed publications, audiovisual broadcasts, audio broadcasts, olfactory enticements, taste samples, etc. Advertising is expensive, and companies try to minimize their advertising costs by determining the most effective means by which to advertise.

One factor in determining effective means of advertising is determining how many people an advertisement will reach. The most effective advertising will reach the most people for the least cost. Currently, crude estimation methods are used to determine how many consumers an advertisement may reach. Therefore, there is a need for improved methods directed towards determining the number of consumers an advertisement reaches.

The type of consumers that an advertisement reaches may be another factor in determining the effectiveness of advertising. Some companies may only wish to advertise their goods and services to specific types of consumers. For instance, sweetened cereal company may only wish to deliver advertisements to children. However, as with estimations of the number of consumers and advertisement reaches, similar crude estimations are used to determine the type of consumers advertisements reach. Therefore, there is a need for improved methods of determining the type of consumers that advertisements reach.

### SUMMARY OF THE INVENTION

The present invention relates to systems and methods for determining the number advertising impressions delivered by advertisements. The present invention also relates to systems and methods for planning advertising schedules and for billing advertising to companies. Herein are disclosed a variety of indexes or estimation modifiers that may be used to improve the accuracy of advertisement estimation. Also disclosed are methods and systems for using the described indexes and modifiers to plan, estimate, and bill advertisements.

In some embodiments, modifiers, e.g., market indexes, channel indexes, day indexes, time indexes, and/or target demographic indexes may be used to analyze advertisements. In one embodiment, an estimate of gross impressions is modified by a factor, such as a channel index, to provide an improved estimate of the efficiency of advertisements. In another embodiment, an estimate of gross impressions may be modified by more than one factor.

In some embodiments, the improved estimates may be used to improve billing for advertising. For example, an advertising agency may assign a higher cost to advertisement locations and/or times that reach a larger number of consumers. In other embodiments, improved estimates may be used to determine when or where advertisements are most effectively presented to consumers.

While the methods and systems of the present invention have proven to be particularly useful in the area of advertising, those skilled in the art can appreciate that the methods and processes can be used in a variety of different applications and in a variety of different areas.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a non-limiting example of a system that provides a suitable operating environment for use with embodiments of the invention;

FIG. 2 illustrates a non-limiting example of a system that provides a suitable networking environment for use in some embodiments of the invention;

FIG. 3 illustrates a non-limiting example of a system that provides for Gross Impression Data according to some embodiments of the invention;

FIG. 4 illustrates a non-limiting example of a system that provides Gross Impression Data relative to All Commodity Volume Data according to some embodiments of the invention;

FIG. 5 illustrates a non-limiting example of a system that provides Gross Impression Per Spot Data according to some embodiments of the invention;

FIG. 6 illustrates a non-limiting example of a system that provides Market Index Data according to some embodiments of the invention;

FIG. 7 illustrates a non-limiting example of a system that provides Channel Index Data according to some embodiments of the invention;

FIG. 8 illustrates a non-limiting example of a system that provides Day/Time Index Data according to some embodiments of the invention; and

FIG. 9 illustrates a non-limiting example of a system that provides Demographic Index Data according to some embodiments of the invention.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to methods and systems for planning, estimating, and billing advertising impressions. More particularly, the present invention relates to methods and systems for planning, estimating, and billing advertising impressions by the use of indexes and measures, e.g., market, channel, time, demographic, category, brand, and/or population indexes.

The following disclosure of the present invention is grouped into subheadings. The utilization of the subheadings is for convenience of the reader only and is not to be construed as limiting in any sense.

### Exemplary Operating Environment

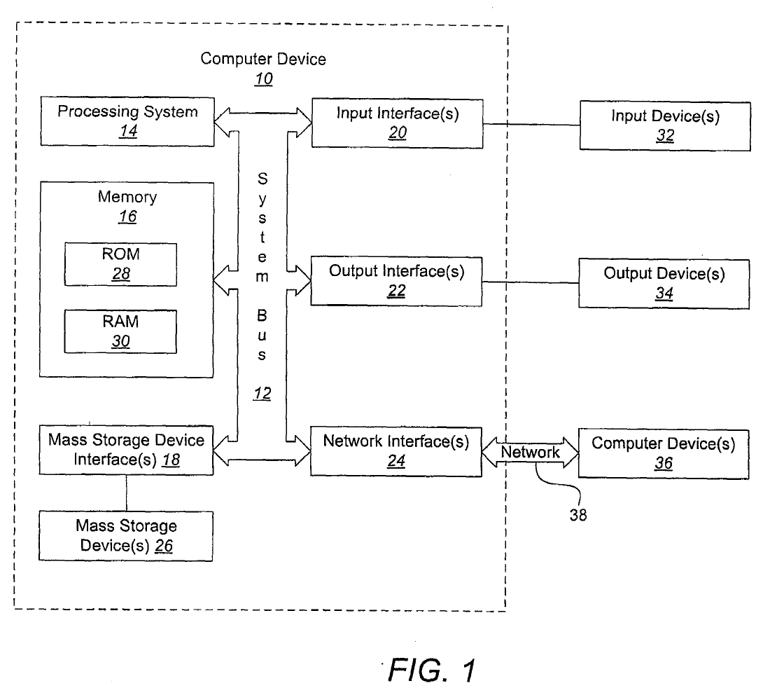

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

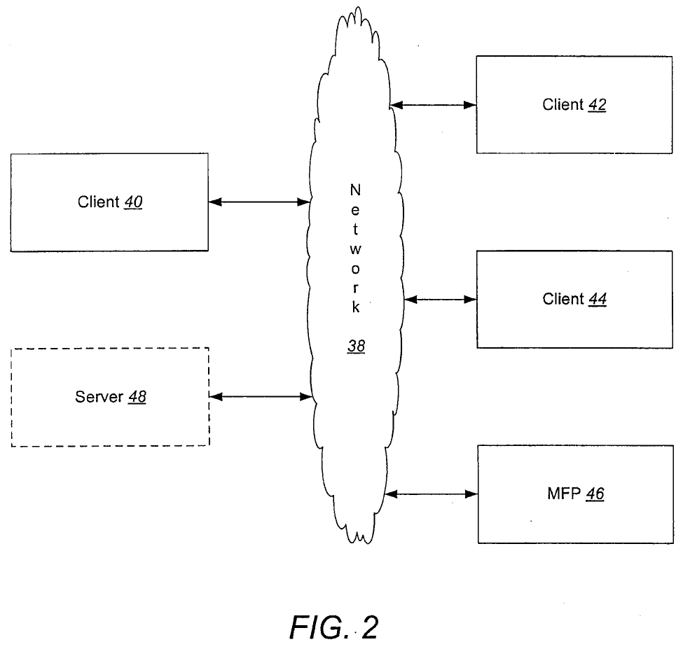

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

### Planning and Estimating Advertising Impressions

The present invention relates to methods and systems for planning and estimating the number of advertising impressions delivered by an advertising system. In some embodiments, the estimated advertising impressions may be calculated using a variety of measures, estimates, and/or indexes.

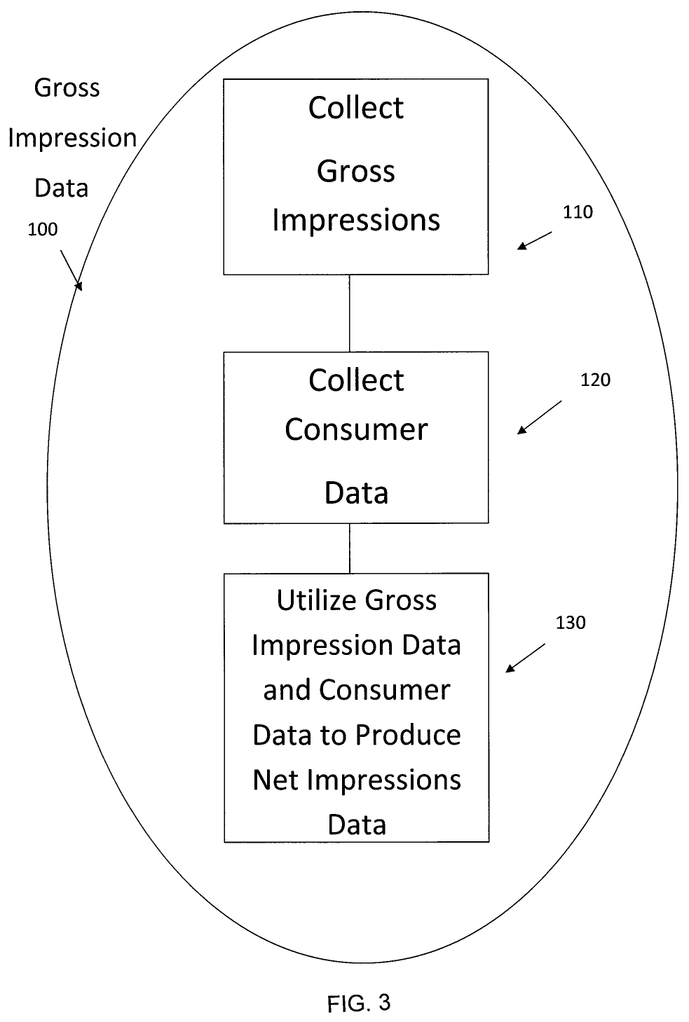

Referring to FIG. 3, advertising impressions are a measure of how many consumers an advertisement reaches 100 referred to as Gross Impressions Data. For example, Gross impressions (GI) data 110 may be collected, and may refer to the total count of advertising exposures delivered by an advertisement. If a consumer is exposed to the advertisement more than once then the number of gross impressions is incremented for each exposure. Customer Data 120 may be collected to determine the number of times a particular customer has been exposed to an advertisement. Net Impressions (NI) 130 is the total count of consumers that an advertisement reaches. Once a consumer has been exposed to an advertisement the number of net impressions is not incremented if the consumer is exposed to the advertisement repeatedly. Other measures of advertising impressions may be used with the present invention, and the teachings of the invention are not limited in anyway by description of the invention with regard to any particular measure.

The methods and systems of the invention will be explained with reference to measures, estimates, and indexes, which are further described below. The invention is not limited to practice with only the measures, estimates, and indexes described below. The description of the measures, estimates, and indexes is illustrative only, and the scope of the invention is determined by the appended claims. Accordingly, the invention may be used with a variety of measures, estimates, indexes, and other factors that will be apparent to one of skill in the art upon reading this disclosure.

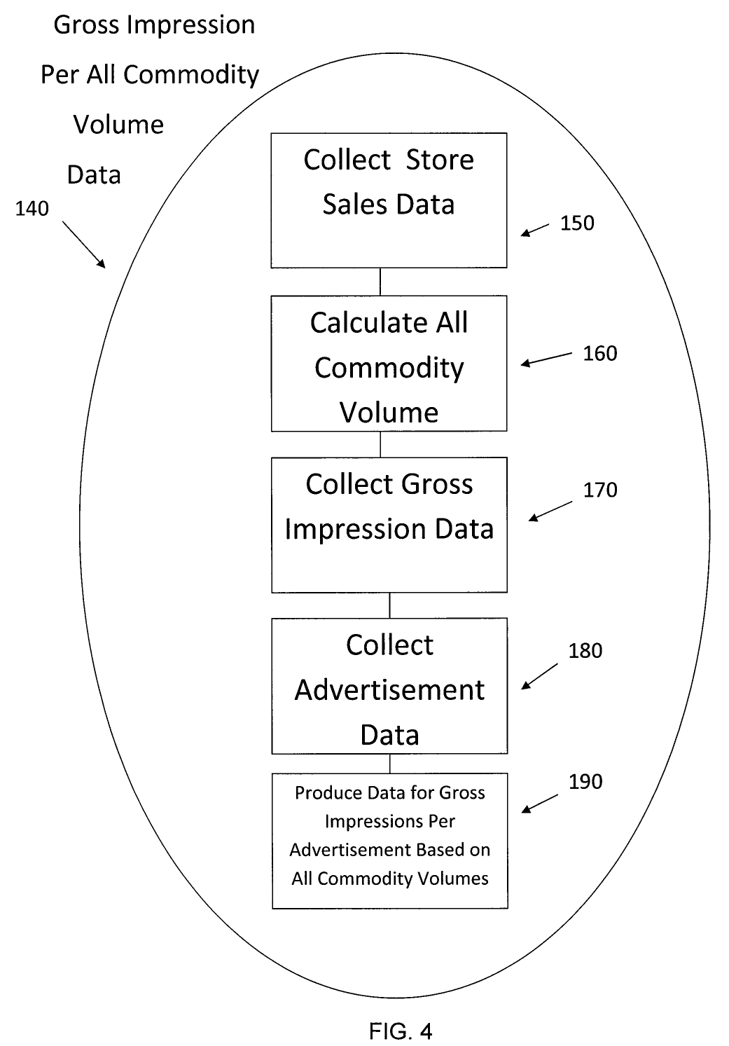

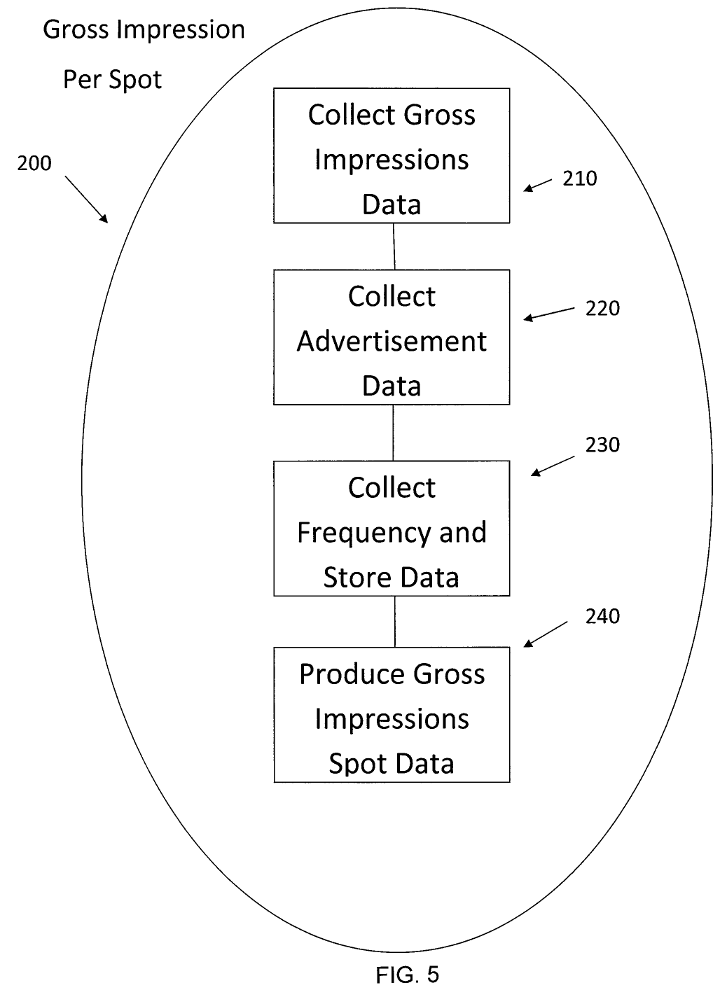

Referring to FIG. 4, some embodiments may be utilized to produce Gross Impression per All Commodity Volume (ACV) data 140. The GI Per Thousand ACV Per Spot may be a measure of gross impressions 170 per advertisement spot based on All Commodity Volume (ACV) 160 expressed in thousands. ACV 160 is a measure of store sales 150, and the use of ACV 160 as a measure should not be construed as limiting of the measures that may be used with the present invention. An embodiment of the calculation of a GI Per Thousand ACV Per Spot 140 is shown in equation 1,

$${GIPerACV}_{1000} PerSpot = \frac{( GI )}{( \frac{ACV}{1000} ) ( Days ) ( Spots )} \qquad ( 1 )$$

where “GI” 170 is an estimate of the total number of gross impressions for a reporting period, “A VC” is the All Commodity Value or total sales during the reporting period 160, “Days” is the number of days in the reporting period, and “Spots” is the number of advertisements per day, which may collectively be referred to as advertisement data 180. For example, in a network generating an estimated 100 million gross impressions every 4 weeks with sales of $600 million running 12 spots per day, the GI Per Thousand ACV Per Spot is 0.49603175. Accordingly, the aggregation of Store Sales Data 150, All Commodity Volume 160, GI Data 170, and Advertisement Data 180 may be utilized to produce Gross Impression per Advertisement on All Commodity Volumes Data 190 Referring to FIG. 5, some embodiments may be utilized to produce Gross Impressions per Advertising Spot data. The GI Per Spot may be a measure of the average number of gross impressions per advertisement. An embodiment of the calculation of a GI Per Spot is shown in equation 2,

$$GIPerSpot = \frac{( GI )}{( Days ) ( Spots ) ( Stores )} \qquad ( 2 )$$

where “GI” is the average total number of gross impressions per advertisement for a reporting period 210, “Spots” is the number of spots aired per day, which may be referred to as Advertising Dates 220, “Days” is the number of days in the reporting period for an advertisement, and “Stores” is the number of stores running the advertisement, which may collectively be referred to as Frequency and Store Data 230. For example, in an advertising network generating an estimated 100 million gross impressions every 4 weeks across 1000 stores running 12 spots per day, the GI per Spot would be 297.62.

In some embodiments Store Gross Impressions per Advertising Spot data 240 may be produced. Store GI Per Spot 200 is a measure of the gross impressions 210 per spot 220 in a given store 230. An embodiment of the calculation of a Store GI Spot is shown in equation 3,

StoreGIPerSpot=GIPerACV₁₀₀₀PerSpot×StoreACV/1000 (3)

where “GIPerACV₁₀₀₀PerSpot” 240 is the measure of gross impressions 210 per advertisement spot 220 based on All Commodity Volume (ACV) 230 expressed in thousands as described with reference to equation 1, “StoreAVC” is the All Commodity Value or total sales during the reporting period for a particular store 230. For example, in a network with a GIPerACV₁₀₀₀PerSpot of 0.49603175 as calculated above and in a store with $750 thousand in sales, the Store GI Per Spot is 372.

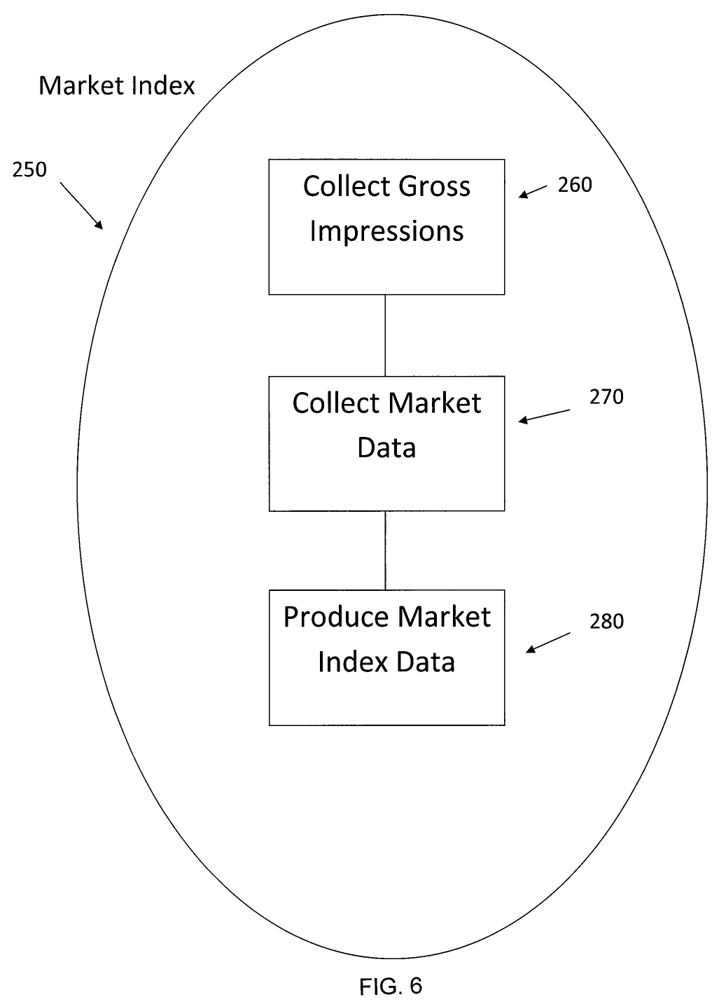

Referring to FIG. 6, some embodiments may be utilized to produce data 280 relative to determining the gross impressions 260 expected from a particular market 270, referred to as Market Index data 250. The Market Index 250 may be a measure of the gross impressions 260 expected from particular market 270. In one embodiment, a market may refer to a Nielsen Designated Market Area (DMA). In another embodiment, a market may refer to any definition of a market, e.g., Metropolitan Statistical Area (MSA), City, Zip Code, etc. An embodiment of the calculation of a Market Index 250 is shown in equation 4,

$$MarketIndex = \frac{( GI )}{( Stores ) ( GIPerStore )} \times 100 \qquad ( 4 )$$

where “GI” is the gross impressions 260 for a given market 270, “Stores” is the number of stores in the given market 270, and “GIPerStore” is the average gross impressions per store in the given market. For example, in an advertising network generating an estimated 100 million gross impressions across 1000 stores, the Market Index 280 for a city delivering an estimated 65 thousand gross impressions across 50 stores is 130.

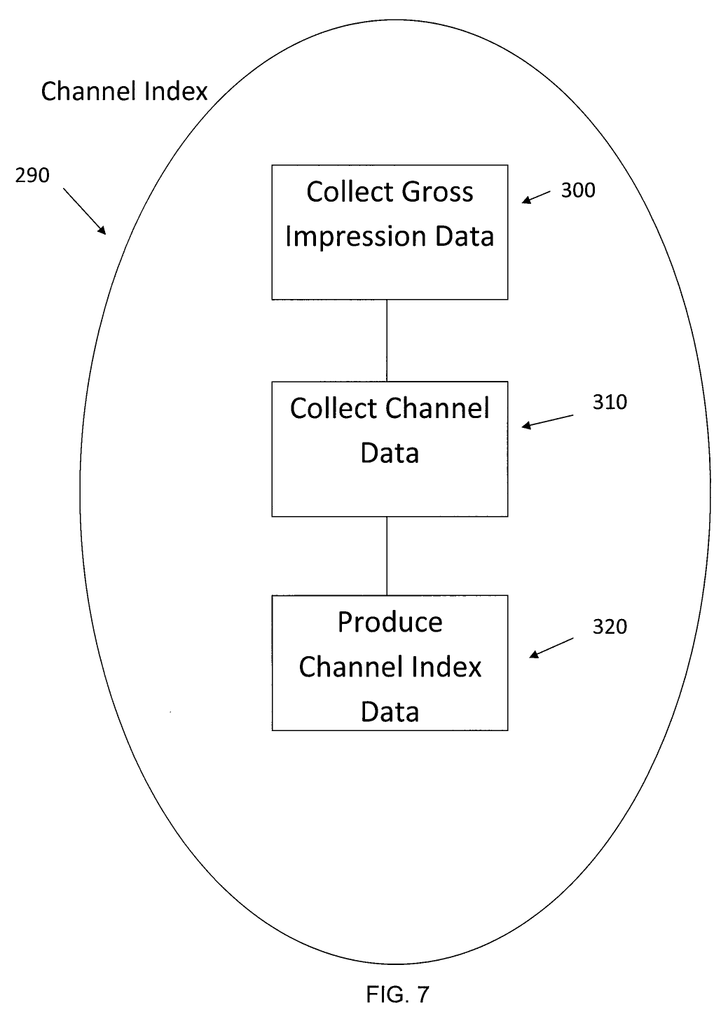

Referring to FIG. 7, some embodiments may be utilized to produce Channel Index data 320. The Channel Index 290 may be a measure of the gross impressions 300 delivered by a particular channel 310 in a multi-channel advertising system. In one embodiment, the Channel Index 290 of a high-traffic channel may be higher than the Channel Index 290 of a low-traffic channel. An embodiment of the calculation of a Channel Index 290 is shown in equation 5,

$$ChannelIndex = \frac{( ChannelGI )}{( BaseChannelGI )} \times 100 \qquad ( 5 )$$

where “ChannelGI” is the estimated gross impressions 300 for a given channel 310, and “BaseChannelGI” is the estimated gross impressions for a base channel, which in some embodiments may be an average of the gross impressions for all the channels in an advertising network. For example, in a network that has a base channel that delivers an estimated 100 million gross impressions, the Channel Index 320 of a channel that delivers 125 million gross impressions is 125.

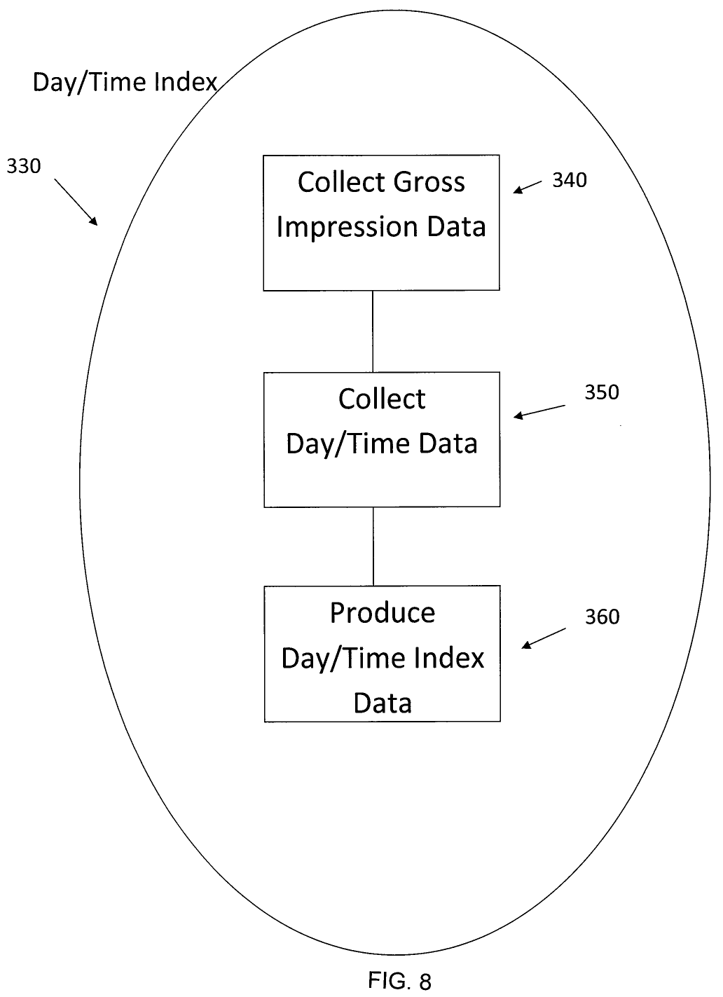

Referring to FIG. 8, some embodiments may be utilized to produce Day and or Time Index Data 330. The Day Index 330 may be a measure of consumer traffic for a given day 350. Higher consumer traffic likely leads to a higher number of gross impressions. An embodiment of the calculation of a Day Index 330 is shown in equation 6,

$$DayIndex = \frac{( DayTraffic )}{( BaseTraffic )} \times 100 \qquad ( 6 )$$

where “DayTraffic” 350 is a measure of consumer traffic on a given day, and “BaseTraffic” is a measure of the consumer traffic on a base day 350, which in some embodiments may be an average of the traffic for all days 350. For example, in an area with an average daily traffic of 87.4, the Day Index 330 of a day with a traffic measure of 100 is 114.

The Time Index 330 may be a measure of consumer traffic for a given time interval. In some embodiments, the Time Index 330 may compare traffic measures for each hour of the day. In other embodiments, the Time Index 330 may be indicative of traffic during 6-hour segments of the day. Any division of time may be used when calculating a Time Index 330. An embodiment of the calculation of a Time Index is shown in equation 7,

$$TimeIndex = \frac{( TimeTraffic )}{( BaseTraffic )} \times 100 \qquad ( 7 )$$

where “TimeTraffic” 350 is a measure of traffic during a given time interval, and “BaseTraffic” is a measure of traffic during a base interval, which in some embodiments may be an average of traffic over all time intervals. For example, in an area with an average traffic of 62.5, the Time Index of a time period with a traffic measure of 50 is 80. Both Day and Time Traffic Data 350 may be enhanced by incorporating GI Data 340 to augment and/or produce Day/Time Index Data 360.

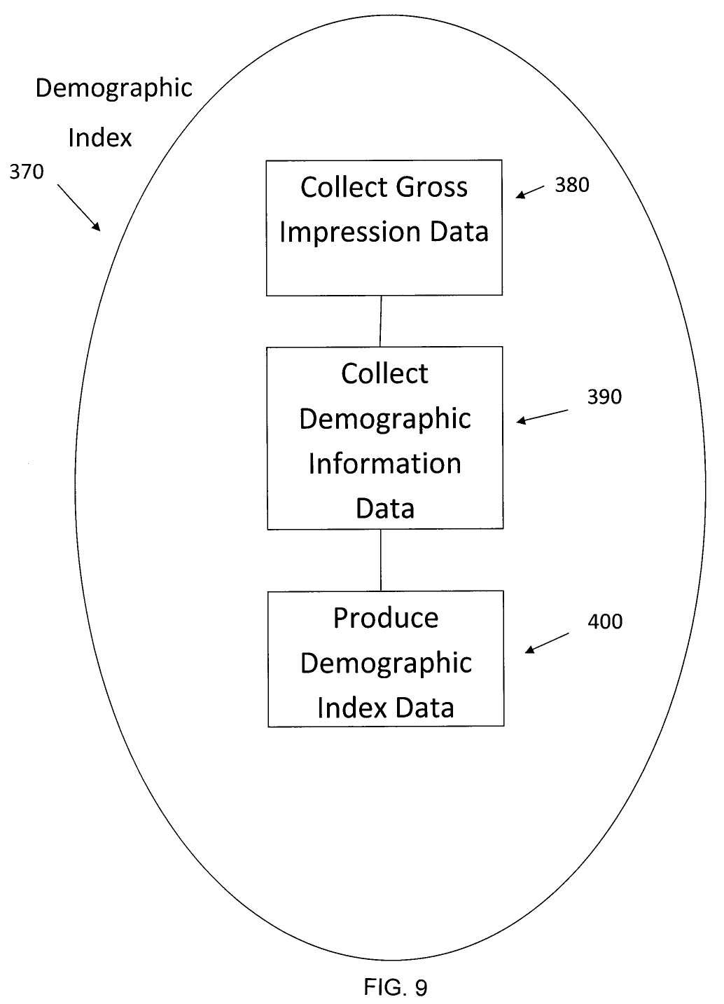

Referring to FIG. 9, some embodiments may be utilized to produce Demographic Index Data 400. The Demographic Index 370 may be a measure the number of gross impressions 380 that reach a target demographic. An embodiment of the calculation of a Demographic Index 370 is shown in equation 8.

$$DemographicIndex = \frac{( DemographicGI )}{( BaseDemographicGI )} \times 100 \qquad ( 8 )$$

where “DemographicGI” is an estimate of the gross impressions 380 delivered to a target demographic 390, and “BaseDemographicGI” is an estimate of the gross impressions 380 delivered to a base demographic, which in some embodiments may be an average of the gross impressions 380 delivered to each demographic 390. For example, if the base demographic receives an estimated 100 million gross impressions and the target demographic receives an estimated 45 million gross impressions then the Demographic Index for the target demographic is 45.

Demographic Information 39 may be acquired by using customer loyalty information or by utilizing customer tracking information.

In some embodiments of a method for collecting Demographic Information begins by a consumer placing or activating a loyalty tracking device on a personal mobile communications device. In some embodiments, the loyalty tracking device specifically identifies the individual by a serial number or by some other identification means. In some embodiments, the mobile communications device used by a consumer may be a mobile phone, a PDA, or any other mobile, bi-directional communication device.

In some embodiments, the tracking device associated with an individual may not contain the customer's loyalty tracking information, or may not contain information previously disposed on the system by the individual. In a non-limiting example, a customer may enter a grocery marketplace or other commercial marketplace, once within range of tracking devices, some embodiments of this system may track the individual through a retail environment, uniquely identifying the individual by a serial number or other means of identification uncorrelated with or not in connection with personal data supplied by the consumer. Accordingly, in some embodiments consumer X may be tracked through a given store or through multiple stores and, their shopping behaviors and purchasing habits may be acquired.

In some embodiments, a consumer may provide data which may be used as a basis for correlating the loyalty data tracking to produce Demographic Information 390. In some embodiments, a customer may log onto a web site and provide personal information comprising name, address and certain shopping preferences. That personal data, in some embodiments, is correlated with a particular shopper and when that shopper enters the shopping environment, the tracking information acquired by tracking the consumer's mobile device through the shopping environment is correlated with the shopper's personal data. In some embodiments, the personal data and real time knowledge of the customer's position in a retail environment can allow for customer specific and geographic specific Demographic Information 390 to be produced. Additionally, in other embodiments, the data provided by a customer may be correlated with the particular geographical position of a consumer in a retail environment and more detailed Demographic Information 390 germane to that customer's preferences and to the geographic position of that customer in a retail environment may be supplied to produce Demographic Index Data 400.

In some embodiments of the present invention, the mobile communications device carried by an individual will contain data that uniquely identifies the individual and may be utilized to further populate Demographic Data 390 for use in some embodiments. In a non-limiting example, a mobile phone carried by a customer may have a customer identification number associated with it, so that any tracking information received from the mobile communications device would be associated with a serial number particularly associated with a specific individual customer. In this way, some embodiments are capable of associating the shopping behaviors and purchasing habits with a particular individual.

In some embodiments, at any given time a consumer may enter a retail establishment. If such a customer has placed or activated a loyalty tracking device on a personal mobile communications device that consumer's shopping behaviors are then tracked. Even if no loyalty device has been activated, a consumer may be as previously discussed tracked through a retail environment, wherein the tracking information is stored accumulated and processed independent of personal information that may have otherwise been provided by the shopper.

In some embodiments of the present invention, the method of acquiring data about the shopping habits of a particular individual to produce Demographic Information Data 390 is accomplished by locating a position identifying marker on a mobile communications device carried by an individual. In a non-limiting example an individual may carry a mobile phone with a global positioning system on-board, or some other tracking means including RFID tags. Additionally, a consumer may use a PDA, or other device with bluetooth technology. The data acquired by tracking an individual through a shopping environment may include the duration of time spent in any given shopping environment, and may include the path taken by a customer as they traverse the shopping environment

In some embodiments, the data created by tracking shopper's consumer behaviors are correlated with a specific customer identification number, previously supplied personal information and/or previously acquired loyalty tracking data to produce Demographic Information Data 390. Even if data was not previously supplied by or previously acquired a particular customer, a customer identification number may be assigned to any customer tracked through the retail environment. In some embodiments, the customer data related to the customer's movements through a shopping environment, duration of time spent in a given shopping environment and itemized list of items purchased may be correlated with customer loyalty information. Accordingly, some embodiments of the present invention provides a system for correlating the path taken, the duration taken at any point, items purchased in a particular shopping experience by a given individual, and such data may be correlated with a specific customer identification number, or other means for uniquely identifying a particular shopper. In some embodiments, the tracking data which has been correlated with a specific customer ID may be stored for subsequent use.

In some embodiments, Demographic Information Data 390 may be augmented with advertisement variable settings data. For example, a consumer enters a retail environments establishment and is subsequently exposed to a broadcast of a plurality of advertisements with unique variable settings. Initially, in some embodiments, the plurality of advertisements are broadcast with unique advertising variable settings. These advertisements are actual advertisements that broadcast with known advertising variable settings. Each of a plurality of broadcast advertisements has unique advertising variable settings. The act of broadcasting a plurality of test advertisements includes recording customer response data that may be correlated with each of the test advertisements to produce augmented Demographic Information Data 390.

Once the plurality of test advertisements are broadcasted, the advertising variable settings of each of the test advertisements may be analyzed in relation to the corresponding customer response data. It may be desirable to attempt to correlate which advertising variable settings affect which customer groups by identifying which test advertisements cause customers to respond in positive ways. Naturally, some customer groups will overlap with one another and certain advertising variable settings may affect customer groups in different ways. This analysis can be performed manually, automatically, or some combination thereof. Various automatic computer algorithms could be used which are known to those skilled in the art.

Once the analysis is complete, a set of optimized advertisement variables is created for a particular advertising target group or for a particular individual. The set of optimized advertising variable settings may or may not be a complete set of advertising variable settings and may be collected as part of Demographic Information Data 390.

Other measures, estimates, and indexes for use with the invention may be calculated in ways similar to those described above. For instance, category indexes, brand indexes, population indexes, etc. may be useful in planning, estimating, and billing advertisements. Accordingly, the above described indexes are merely illustrative examples of some measures, estimates, and indexes that may be used with the present invention.

The above described measures, estimates, and indexes may used by an advertiser to plan and estimate the number of gross impressions that will be delivered by an advertisement. For example, if an advertiser desires to achieve a certain number gross impressions with a given advertisement. The indexes described above may help the advertiser choose when, where, and how to advertise in order to achieve the desired number of gross impressions. Using other indexes, estimates, and/or measures, an advertiser may plan how to deliver a desired number of gross impressions to a desired demographic. Alternatively, an advertiser may use measures, estimates, and indexes after an advertisement to estimate the number of gross impressions generated by the advertisement.

The measures, estimates, and indexes of the invention may also be used by advertisers in order to more accurately bill for advertising. For example, an advertiser may bill based upon how many gross impressions were delivered by an advertisement. The advertiser may use the described methods to more accurately estimate the gross impressions delivered by an advertisement. Alternatively, an advertiser may use the measures, estimations, and indexes to assign a price to a particular advertising time, place, or method depending upon how many gross impressions are estimated to be delivered.

Thus, as discussed herein, the embodiments of the present invention embrace systems and methods for planning, estimating, and billing advertising impressions. More particularly, the present invention relates to systems and methods for planning, estimating, and billing advertising impressions by the use of indexes and measures, e.g., market, channel, time, demographic, category, brand, and/or population indexes.

The described measures, estimations, and indexes may be used in a number of ways, and the invention is not limited by the described examples. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A method comprising:
providing data about an advertising network;
calculating at least one index or estimate from the data; and
adjusting advertisement billing rates based upon the at least one index or estimate.

2. A method comprising:
providing data about an advertising network;
calculating at least one index or estimate from the data; and
optimizing an advertising schedule based upon the at least one index or estimate.

3. A method as in claim 1 or 2, wherein the data about an advertising network comprises the total estimated gross impressions for an advertisement, the number of stores running the advertisement, the number of days in a reporting period, and the number of advertisement spots per day; and wherein the at least one index or estimate from the date comprises an estimated number of gross impressions per advertisement spot.

4. A computer program product for implementing within a computer system a method for planning, estimating and billing advertising impressions, the computer program product comprising:
computer readable medium for providing computer program code means utilized to implement the method, wherein the computer program code means is comprised of executable code for implementing the steps for:
providing data about an advertising network;
calculating at least one index or estimate from the data; and
optimizing an advertising schedule based upon the at least one index or estimate.
